(19) United States
(12) Patent Application Publication
(10) Pub. No.: US 2026/0157909 A1
(43) Pub. Date: Jun. 11, 2026

(54) SURGICAL TABLE CLADDING PROTECTION DEVICE AND METHODS

(71) Applicant: D.A. Surgical, Newbury, OH (US)

(72) Inventor: Jacob Taylor Swanson, Mentor, OH (US)

(21) Appl. No.: 19/410,420

(22) Filed: Dec. 5, 2025

Related U.S. Application Data
(60) Provisional application No. 63/729,001, filed on Dec. 6, 2024.

(51) Int. Cl. A61G 13/12; A61G 13/06

(52) U.S. Cl. CPC A61G 13/129; A61G 13/06

(57) ABSTRACT

A cladding protection device for placement around a column. The cladding protection device includes a first guard having a first side wall. At least one first coupling element is on a free end portion of the first side wall of the first guard. A second guard includes a first side wall. At least one first mating coupling element is on a free end portion of the first side wall of the second guard. At least one lock is configured to slide between an unlocked orientation and a locked orientation when the first guard and the second guard are coupled together, wherein the unlocked orientation is configured to permit decoupling of the first guard and the second guard, and the locked orientation is configured to prevent decoupling of the first guard and the second guard.

### FIELD

1 The present disclosure relates generally to a guard device for a surgical table. More particularly, the application relates to a device that protects cladding segments of a height adjustment mechanism used to raise or lower a surgical table.

### BACKGROUND

Medical facilities commonly utilize surgical tables that can be repositioned to ergonomically accommodate medical personnel (e.g., surgeons, anesthesiologists, nurses, etc.) performing a medical procedure on a patient. Such surgical tables generally include a repositioning mechanism that is operable to control the level and orientation of the surgical table. The repositioning mechanism is typically surrounded by a telescoping cladding assembly including a plurality of cladding segments arranged between a base and a lower surface of the table.

Many medical personnel temporarily store items near or on the base of the surgical table. In some cases, these items may inadvertently be moved against the telescoping cladding assembly. Such items can become lodged beneath a lip of one or more of the cladding segments of the telescoping assembly. This may damage the cladding assembly, thereby rendering the table inoperable. In such cases, this may require a medical institution to incur costs for fixing or replacing a damaged table.

Therefore, it is desirable to provide a cladding protection device that prevents items placed on or near the base of the table from inadvertently damaging the cladding assembly of the surgical table.

### SUMMARY

The following presents a simplified summary of the disclosure to provide a basic understanding of some aspects described in the detailed description.

There is provided a cladding protection device for placement around a column. The cladding protection device includes a first guard having a first side wall. At least one first coupling element is on a free end portion of the first side wall of the first guard. A second guard includes a first side wall. At least one first mating coupling element is on a free end portion of the first side wall of the second guard, wherein the at least one first coupling element of the first guard is configured to engage the at least one first mating coupling element of the second guard to couple the first guard and the second guard together. At least one lock is configured to slide between an unlocked orientation and a locked orientation when the first guard and the second guard are coupled together, wherein the unlocked orientation is configured to permit decoupling of the first guard and the second guard, and the locked orientation is configured to prevent decoupling of the first guard and the second guard.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 is a perspective view of an exemplary surgical table;

FIG. 2 is an enlarged perspective view of an exemplary damaged surgical table cladding assembly;

FIG. 3 is an exploded view of a cladding protection device, in accordance with aspects of the present disclosure;

FIG. 4A illustrates a left side view of a first guard of the cladding protection device of FIG. 3, in accordance with aspects of the present disclosure;

FIG. 4B illustrates a front view of a first guard of the cladding protection device of FIG. 3, in accordance with aspects of the present disclosure;

FIG. 4C illustrates a right side view of a first guard of the cladding protection device of FIG. 3, in accordance with aspects of the present disclosure;

FIG. 4D illustrates a bottom view of a first guard of the cladding protection device of FIG. 3, in accordance with aspects of the present disclosure;

FIG. 4E illustrates a perspective view of a first guard of the cladding protection device of FIG. 3, in accordance with aspects of the present disclosure;

FIG. 5A illustrates a left side view of a second guard of the cladding protection device of FIG. 3, in accordance with aspects of the present disclosure;

FIG. 5B illustrates a front view of a second guard of the cladding protection device of FIG. 3, in accordance with aspects of the present disclosure;

FIG. 5C illustrates a right side view of a second guard of the cladding protection device of FIG. 3, in accordance with aspects of the present disclosure;

FIG. 5D illustrates a bottom view of a second guard of the cladding protection device of FIG. 3, in accordance with aspects of the present disclosure;

FIG. 5E illustrates a perspective view of a second guard of the cladding protection device of FIG. 3, in accordance with aspects of the present disclosure;

FIG. 6A illustrates a side view of a first lock of the cladding protection device of FIG. 3, in accordance with aspects of the present disclosure;

FIG. 6B illustrates a front view of a first lock of the cladding protection device of FIG. 3, in accordance with aspects of the present disclosure;

FIG. 6C illustrates a perspective view of a first lock of the cladding protection device of FIG. 3, in accordance with aspects of the present disclosure;

FIG. 7A illustrates a side view of a second lock of the cladding protection device of FIG. 3, in accordance with aspects of the present disclosure;

FIG. 7B illustrates a front view of a second lock of the cladding protection device of FIG. 3, in accordance with aspects of the present disclosure;

FIG. 7C illustrates a perspective view of a second lock of the cladding protection device of FIG. 3, in accordance with aspects of the present disclosure;

FIG. 8 is a partially assembled front view of the cladding protection device, illustrating the first lock and the second lock in unlocked orientations, in accordance with aspects of the present disclosure;

FIG. 9 is a partially assembled perspective view of the cladding protection device, illustrating the first lock and the second lock in the unlocked orientations, in accordance with aspects of the present disclosure;

FIG. 10 is a fully assembled front view of the cladding protection device, illustrating the first guard and the second guard coupled together with the first lock and the second lock in the locked orientations, in accordance with aspects of the present disclosure; and

FIG. 11 is a fully assembled perspective view of the cladding protection device, illustrating the first guard and the second guard coupled together with the first lock and the second lock in the locked orientations, in accordance with aspects of the present disclosure.

### DETAILED DESCRIPTION

Aspects 1 will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising,” “including,” and variations thereof shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

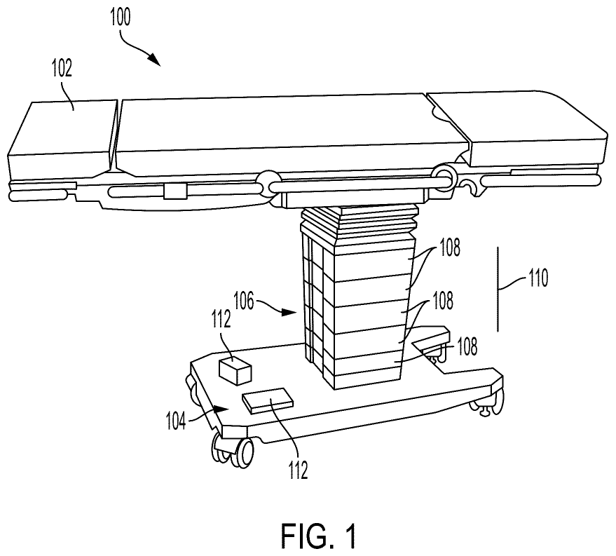

Referring to FIG. 1, an exemplary surgical table 100 (e.g., operating room table, procedure table, etc.) is illustrated. In aspects, the surgical table 100 can comprise a patient support surface 102 and a base 104. The patient support surface 102 can be configured to support the weight of a patient during a surgical procedure. In further aspects, the surgical table 100 can comprise a column 106 extending between the base 104 and the patient support surface 102. In aspects, the column 106 can comprise a height adjustment mechanism (not shown) configured to adjust the height (e.g., in a vertical direction) of the patient support surface 102. In aspects, the height adjustment mechanism (not shown) can be surrounded by a movable shroud or cladding made up of a plurality of telescoping shroud members 108. The telescoping shroud members 108 can be configured to enclose an internal mechanism (e.g., electronic and mechanical controls, not shown) that is operable to reposition the patient support surface 102 relative to the base 104 of the surgical table 100. While FIG. 1 illustrates five telescoping shroud members 108, in some embodiments, the surgical table 100 can include more or less than five telescoping shroud members 108 (e.g., two, four, six, seven, etc.).

In aspects, the telescoping shroud members 108 can be movable in the direction indicated by line 110 in FIG. 1, during repositioning of the patient support surface 102 by the height adjustment mechanism (not shown). One or more of the telescoping shroud members 108 can be dimensioned to be nested within an adjacent telescoping shroud member 108 when the patient support surface 102 moves relative to the base 104 of the surgical table 100.

The surgical table 100 illustrated in FIG. 1 and described above is presented by way of example and is not intended to be limiting. Rather, the surgical table 100 is provided in order to facilitate discussion of various features of the present disclosure. Any of the features described herein may be incorporated into, or used in conjunction with, any other suitable surgical table, including surgical tables having various different, alternative, and/or additional components and/or features not shown in FIG. 1 or otherwise described herein.

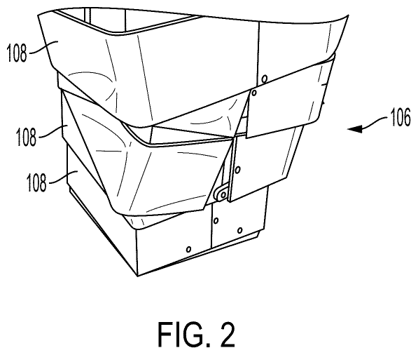

As shown in FIG. 1, it is common for medical personnel (e.g., anesthesiologists, nurses, surgeons, etc.) to store various items 112 (e.g., SDC machines, arm boards, clark sockets, rail clamps, etc.) on or near the base 104 of the surgical table 100. During surgery, these items may inadvertently become lodged beneath a lip of one of the telescoping shroud members 108. As generally illustrated in FIG. 2, such items may damage the telescoping shroud members 108, for example, when the height adjustment mechanism is operated to lower the patient support surface 102. As illustrated in FIG. 2, the telescoping shroud members 108 can become disconnected from one another, bent, and/or cracked. In some cases, this can limit or entirely prevent the usability of the surgical table 100 by inhibiting the adjustability of the patient support surface 102.

Referring to FIG. 3, a cladding protection device 300 for placement around the column 106 is shown. For example, the cladding protection device 300 can be positioned at least partially around the column 106. In this way, the cladding protection device 300 can help to reduce the likelihood that the items 112 on or near the base 104 of the surgical table 100 may damage or otherwise contact the telescoping shroud members 108.

In aspects, the cladding protection device 300 can comprise a first guard 302 and a second guard 304. The first guard 302 and the second guard 304 may be formed of metal having a uniform thickness. It is contemplated that the first guard 302 and the second guard 304 (or at least a main body thereof without attachments thereto) may be integrally formed from a single piece of metal that is bent, cut, and shaped into the final configuration of the respective first guard 302 and second guard 304. In other embodiments, one or more elements of the first guard 302 and the second guard 304 (or even the entire guard) may be formed of one or more other suitable materials, including, but not limited to, a plastic material.

In further aspects, the cladding protection device 300 can include at least one lock. In one example, the cladding protection device 300 can include only a single lock. However, in other examples, as shown, the cladding protection device 300 can include a first lock 306 and a second lock 308. The first lock 306 and the second lock 308 will be discussed in more detail below.

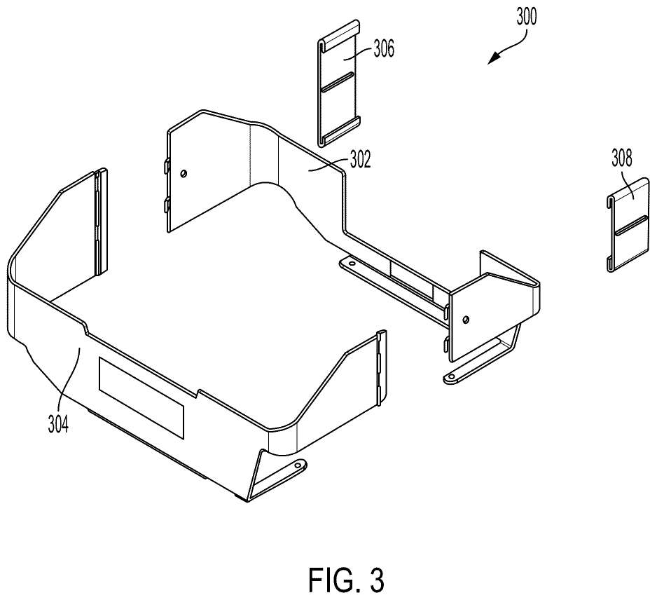

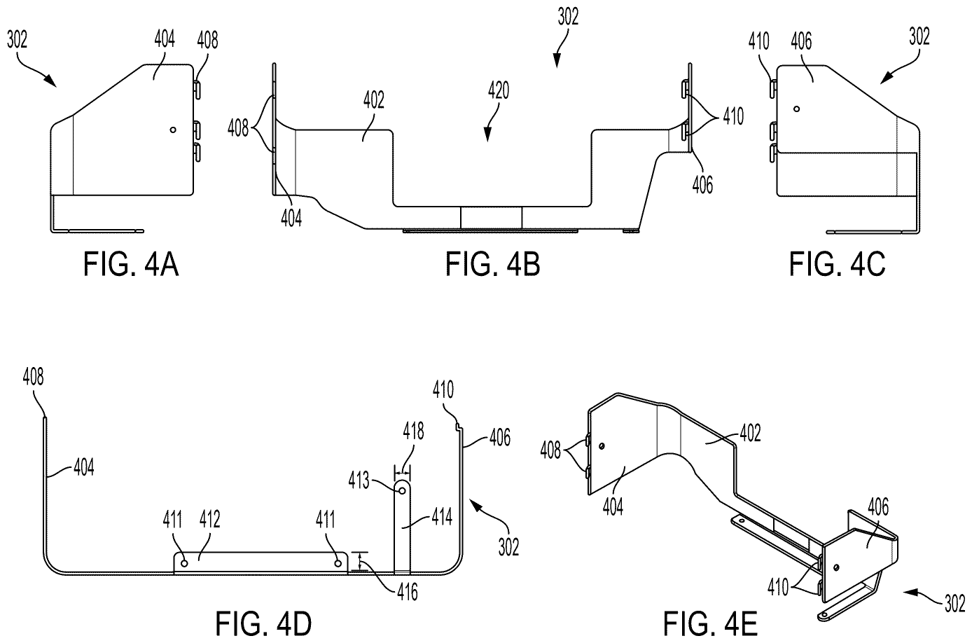

Referring to FIGS. 4A-4E, the first guard 302 is shown. In aspects, the first guard 302 can comprise a central wall 402, a first side wall 404, and a second side wall 406. The first side wall 404 and the second side wall 406 of the first guard 302 can be positioned at opposite ends of the central wall 402 and can extend from a side of the central wall 402. In aspects, the central wall 402, the first side wall 404, and the second side wall 406 of the first guard 302 together can define a U-shape. In the embodiment shown, the first side wall 404 and the second side wall 406 extend in a perpendicular direction from the central wall 402. However, it is contemplated that the first side wall 404 and the second side wall 406 may extend from the central wall 402 at any other angle other than perpendicular based on the shape of the column 106.

The central wall 402, the first side wall 404, and/or the second side wall 406 can be substantially planar in shape. The term “planar” as utilized herein is intended to mean one or both sides of the central wall 402, the first side wall 404, and/or the second side wall 406 exhibit a relatively flat geometric profile such that one or both sides lie generally in a single flat geometric plane. However, in other aspects, one or more portions of any one of the central wall 402, the first side wall 404, and/or the second side wall 406 can be non-planar. For example, the central wall 402, the first side wall 404, and/or the second side wall 406 can comprise one or more strengthening features (not specifically shown), such as for example, beads, ribs, embossings, corrugations, surface flutes, surface channels, rolled edges, curled edges, and/or the like. The strengthening features can extend across a length (e.g., a partial or full length) and/or a width (e.g., a partial or full width) of any one or all of the central wall 402, the first side wall 404, and/or the second side wall 406. In some examples, the central wall 402, the first side wall 404, and/or the second side wall 406 can be defined by entirely non-planar shapes, such as for example, having continuously curved walls or wall segments. In some such examples, this can be beneficial to facilitate placing the first guard 302 around various other surgical tables, such as for example, where a portion of the column of a surgical table is not generally square or rectangular as is illustrated in FIG. 1. In this way, the first guard 302 can resemble a general outer shape of at least a portion of the column. The term “non-planar” as used herein is intended to refer to surfaces that deviate from a flat plane, including but not limited to curved, faceted, or irregular profiles.

In some examples, as illustrated in FIGS. 4A-4E, a height of the first side wall 404 and the second side wall 406 can be different. In the illustrated embodiment, the height of the first side wall 404 can be greater than the height of the second side wall 406. However, it is contemplated that the height of the second side wall 406 can be greater than the height of the first side wall 404 or the first side wall 404 and the second side wall 406 can be the same height.

In some aspects, as best shown in FIG. 4B, a lower most edge of the first side wall 404 and the second side wall 406 of the first guard 302 can extend from an upper portion of the central wall 402. In the embodiment illustrated, a corner where the first side wall 404 extends from the central wall 402 can be notched such that the corner does not extend to the lower most edge of the central wall 402 or the first side wall 404. Similarly, in the embodiment illustrated, a corner where the second side wall 406 extends from the central wall 402 may be notched such that the corner does not extend to the lower most edge of the central wall 402 or the second side wall 406.

In further aspects, the cladding protection device 300 can comprise at least one first coupling element 408 on a free end portion of the first side wall 404 of the first guard 302. Similarly, the cladding protection device 300 can include at least one second coupling element 410 on a free end portion of the second side wall 406 of the first guard 302. The at least one first coupling element 408 and the at least one second coupling element 410 of the first guard 302 can each comprise an L-shaped projection extending from the free end portion of the respective first side wall 404 and the second side wall 406 of the first guard 302. For example, the at least one first coupling element 408 can include a tab portion extending downwardly from horizontal portions thereof to define the L-shaped projection. The at least one first coupling element 408 can extend from the free end of the first side wall 404 in a direction that is aligned with the first side wall 404 (see, e.g., FIG. 4D). Similarly, the at least one second coupling element 410 can include a tab portion extending downwardly from horizontal portions thereof to define the L-shaped projection. In the specific embodiment shown, the at least one second coupling element 410 are shown as being skewed or bent inwardly relative to an outer surface of the second side wall 406 (see, e.g., FIG. 4D). It is contemplated that the at least one second coupling element 410 may be bent inwardly at an angle between about 40 degrees and about 50 degrees relative to the outer surface of the second side wall, preferably about 45 degrees.

The at least one first coupling element 408 and the at least one second coupling element 410 are dimensioned and positioned to engage at least one first mating coupling element 508 and at least one second mating coupling element 510 of the second guard 304, as discussed in detail below. As illustrated, in some aspects, the at least one first coupling element 408 and the at least one second coupling element 410 can comprise a plurality of coupling elements (e.g., two, three, four, etc.). However, in some examples, the cladding protection device 300 may include only a single coupling element. It is contemplated that the at least one first coupling element 408 and the at least one second coupling element 410 may embody other shapes and forms, for example, but not limited to, clips, slots, catches, keys, snaps, hinges, grooves, holes, clasps, magnetic elements, elastic elements, etc.

In further aspects, the first guard 302 of the cladding protection device 300 can comprise at least one mounting tab extending from at least one of the central wall 402, the first side wall 404, and/or the second side wall 406. In the embodiment shown, the cladding protection device 300 includes a first mounting tab 412 and a second mounting tab 414. The first mounting tab 412 and the second mounting tab 414 extend inwardly from the central wall 402 relative to an outer surface of the central wall 402. The first mounting tab 412 and the second mounting tab 414 can include mounting holes 411, 413 for mounting the first guard 302 to the base 104 (FIG. 1). The first mounting tab 412 and the second mounting tab 414 may abut the column 106 (FIG. 1) to space the first guard 302 a desired distance from the column 106. For example, a width 416, 418 of the first mounting tab 412 and the second mounting tab 414, respectively, can define a gap between the respective side wall of the first guard 302 and the respective side of the column 106. The gap may be dimensioned such that the first guard 302 does not interfere with the column 106. It is contemplated that mounting tabs can be additionally or alternatively include on the first side wall 404 and/or the second side wall 406. Furthermore, while two mounting tabs are illustrated more or less tabs can be provided and may be any suitable shape or size (e.g., rectangular shaped tabs, polygonal shaped tabs, round tabs, and/or the like).

In some examples, as shown best in FIG. 4B, the central wall 402 of the first guard 302 can comprise a notch 420. The notch 420 can be formed at an upper edge of the central wall 402. In aspects, the notch 420 can provide clearance in order to prevent interference with one or more portions of the surgical table 100, such as for example, control components (e.g., control cables, power cables, communication interfaces, etc.) or any other component of the surgical table 100. While the central wall 402 of the first guard 302 has been illustrated as having the notch 420, in other embodiments, the first side wall 404 and/or the second side wall 406 of the first guard 302 can additionally or alternatively have the notch 420 or a similar feature, if necessary.

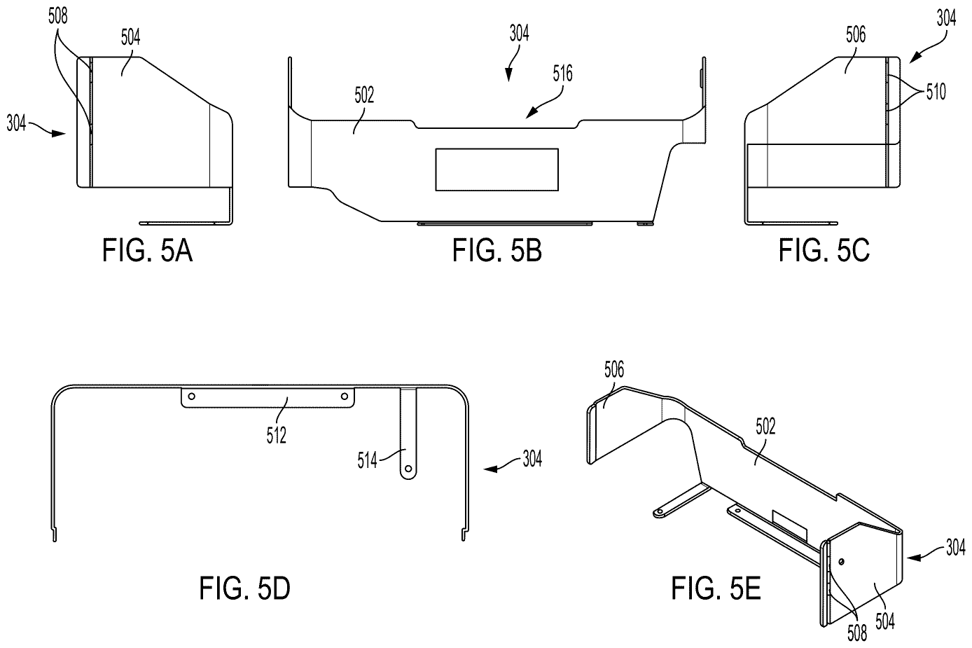

Referring to FIGS. 5A-5E, the second guard 304 is shown. In aspects, the second guard 304 can comprise a central wall 502, a first side wall 504, and a second side wall 506. The first side wall 504 and the second side wall 506 of the second guard 304 can be positioned at opposite ends of the central wall 502 of the second guard 304 and can extend from a side of the central wall 502 of the second guard 304. In aspects, the central wall 502, the first side wall 504, and the second side wall 506 of the second guard 304 together can define a U-shape. In the embodiment shown, the first side wall 504 and the second side wall 506 of the second guard 304 extend in a perpendicular direction from the central wall 502. However, it is contemplated that the first side wall 404 and the second side wall 406 of the second guard 304 may extend from the central wall 502 at any other angle other than perpendicular based on the shape of the column 106.

The central wall 502, the first side wall 504, and/or the second side wall 506 can be substantially planar in shape as described with reference to FIGS. 4A-4E, and thus reference can be made above for further details. However, in other aspects, one or more portions of any one of the central wall 502, the first side wall 504, and/or the second side wall 506 can be non-planar. For example, the central wall 502, the first side wall 504, and/or the second side wall 506 can be non-planar can comprise one or more strengthening features (not specifically shown), such as for example, beads, ribs, embossings, corrugations, surface flutes, surface channels, rolled edges, curled edges, and/or the like. The strengthening features can extend across a length (e.g., a partial or full length) and/or a width (e.g., a partial or full width) of any one or all of the central wall 502, the first side wall 504, and/or the second side wall 506 can be non-planar. In some examples, the central wall 502, the first side wall 504, and/or the second side wall 506 can be defined by entirely non-planar shapes, such as for example, having continuously curved walls or wall segments. As described above with reference to the first guard 302, this can be beneficial to facilitate placing the second guard 304 around various other surgical tables, such as for example, where a portion of the column of a surgical table is not generally square or rectangular as is illustrated in FIG. 1. In this way, the second guard 304 can resemble a general outer shape of at least a portion of the column.

In some examples, as illustrated best in FIG. 5E, a height of the first side wall 504 and the second side wall 506 can be different. In the illustrated embodiment, the height of the first side wall 504 can be greater than the height of the second side wall 506. However, it is contemplated that the height of the second side wall 506 can be greater than the height of the first side wall 504 or the first side wall 504 and the second side wall 506 can be the same height.

In some aspects, as best shown in FIG. 5B, a lower most edge of the first side wall 504 and the second side wall 506 of the second guard 304 can extend from an upper portion of the central wall 502 of the second guard 304 In the embodiment illustrated, a corner where the first side wall 504 extends from the central wall 502 can be notched such that the corner does not extend to the lower most edge of the central wall 502 or the first side wall 504. Similarly, in the embodiment illustrated, a corner where the second side wall 506 extends from the central wall 502 may be notched such that the corner does not extend to the lower most edge of the central wall 502 or the second side wall 506.

In further aspects, the second guard 304 can comprise at least one first mating coupling element 508 on a free end portion of the first side wall 504. Similarly, the second guard 304 can comprise at least one second mating coupling element 510 on a free end portion of the second side wall 506. In aspects, the at least one first mating coupling element 508 and the at least one second mating coupling element 510 of the second guard 304 can each comprise a slot formed in the free end portion of a respective one of the first side wall 504 and the second side wall 506 of the second guard 304. It is contemplated that the at least one first mating coupling element 508 and the at least one second mating coupling element 510 of the second guard 304 may take on other forms (other than slots), for example, but not limited to, clips, hooks, catches, keys, snaps, hinges, grooves, holes, clasps, magnetic elements, elastic elements, etc.

In some examples, such as in the embodiment shown, the free end of the first side wall 504 and the second side wall 506 of the second guard 304 are offset inwardly relative to an outer surface of the respective first side wall 504 and the second side wall 506 (see FIG. 5D). The at least one first mating coupling element 508 and the at least one second mating coupling element 510 (e.g., the slots) can then be formed in a bent portion of the distal end. In this embodiment, the at least one first mating coupling element 508 and the at least one second mating coupling element 510 extend vertically and are dimensioned and positioned to engage with the at least one first coupling element 408 and the at least one second coupling element 410 of the first guard 302, as described in detail below.

In further aspects, the second guard 304 can comprise at least one mounting tab extending from at least one of the central wall 502, the first side wall 504, and/or the second side wall 506 of the second guard 304. In the embodiment shown, the second guard 304 can comprise a first mounting tab 512 and a second mounting tab 514. The first mounting tab 512 and the second mounting tab 514 can be substantially similar to the first mounting tab 412 and the second mounting tab 414, and thus reference can be made above for further details.

In some examples, as shown best in FIG. 5B, the central wall 502 of the second guard 304 can comprise a notch 516. The notch 516 can be formed at an upper edge of the central wall 502 of the second guard 304, as shown. In aspects, the notch 516 can provide clearance in order to prevent interference with one or more portions of the surgical table 100, such as for example, control components (e.g., control cables, power cables, communication interfaces, etc.) or any other component of the surgical table 100. While the central wall 502 of the second guard 304 has been illustrated as having the notch 516, in other embodiments, the first side wall 504 and/or the second side wall 506 of the second guard 304 can additionally or alternatively have the notch 516 or a similar feature, if necessary.

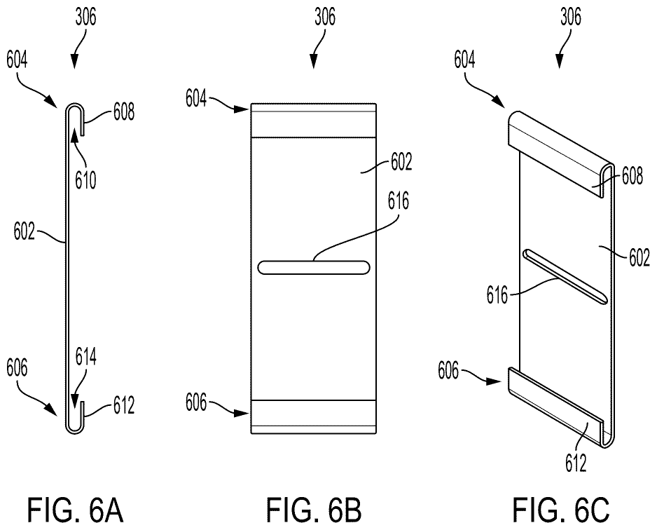

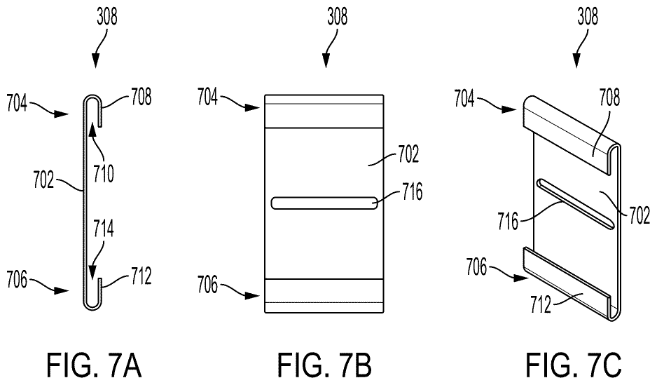

Referring to FIGS. 6A-6C and 7A-7C, the first lock 306 and the second lock 308 are illustrated, respectively. The first lock 306 and the second lock 308 are similar in shape. However, in some examples, the first lock 306 and the second lock 308 can be a different size (e.g., in thickness, length and/or width) in order to accommodate different side wall dimensions. For example, as shown in FIGS. 6A-6C, the first lock 306 can be the same width and thickness as the second lock 308, but a height of the first lock 306 can be larger than that of the second lock 308, since the first side wall 404 of the first guard 302 and the first side wall 504 of the second guard 304 can be greater in height than a height of the second side wall 406 of the first guard 302 and the second side wall 506 of the second guard 304.

Referring specifically to FIGS. 6A-6C, the first lock 306 can comprise a base portion 602. The base portion 602 can include a top edge 604 and a bottom edge 606. In aspects, the first lock 306 can comprise a first curved flange 608 formed at the top edge 604 of the base portion 602. The first curved flange 608 can define an opening 610. The opening 610 can be configured to slidably receive an upper edge of the first side wall 404 of the first guard 302 and an upper edge of the first side wall 504 of the second guard 304 (discussed in more detail below). In additional aspects, the first lock 306 can comprise a second curved flange 612 formed at the bottom edge 606 of the base portion 602. The second curved flange 612 can define an opening 614 configured to slidably receive a lower edge of the first side wall 404 of the first guard 302 and a lower edge of the first side wall 504 of the second guard 304. In the embodiment illustrated, the curved flanges are generally U-shaped and extend an entire length of the corresponding edge of the base portion 602. It is contemplated that the curved flanges may not extend the entire length of the base portion 602, or the curved flanges may be segmented (e.g., can include a plurality of spaced-apart segments).

In some examples, the first lock 306 can further comprise an elongated slot 616 extending through the base portion 602. The elongated slot 616 can extend parallel to the top edge 604 of the base portion 602. The elongated slot 616 can be configured to receive a coupling member to enable the first lock 306 to slide and/or maintain the first lock 306 in a locked orientation or an unlocked orientation (described below).

Referring specifically to FIGS. 7A-7C, the second lock 308 can comprise a base portion 702. The base portion 702 can include a top edge 704 and a bottom edge 706. In aspects, the second lock 308 can comprise a first curved flange 708 formed at the top edge 704 of the base portion 702. The first curved flange 708 can define an opening 710. The opening 710 can be configured to slidably receive an upper edge of the second side wall 406 of the first guard 302 and an upper edge of the second side wall 506 of the second guard 304 (discussed in more detail below). In additional aspects, the second lock 308 can comprise a second curved flange 712 formed at the bottom edge 706 of the base portion 702. The second curved flange 712 can define an opening 714 configured to slidably receive a lower edge of the second side wall 406 of the first guard 302 and a lower edge of the second side wall 506 of the second guard 304. In the embodiment illustrated, the curved flanges are generally U-shaped and extend an entire length of the corresponding edge of the base portion 702. It is contemplated that the curved flanges may not extend the entire length of the base portion 702, or the curved flanges may be segmented (e.g., can include a plurality of spaced-apart segments).

In some examples, the second lock 308 can further comprise an elongated slot 716 extending through the base portion 702. The elongated slot 716 can extend parallel to the top edge 704 of the base portion 702. The elongated slot 716 can be configured to receive a coupling member to enable the second lock 308 to slide and/or maintain the second lock 308 in a locked orientation or an unlocked orientation (described below).

In some examples, the first lock 306 can be utilized to lock the first side wall 404 of the first guard 302 and the first side wall 504 of the second guard 304 together, and the second lock 308 can be utilized to lock the second side wall 406 of the first guard 302 and the second side wall 506 of the second guard 304. While the first lock 306 and the second lock 308 have been described with specific reference to either the first side wall 404 of the first guard 302 and the first side wall 504 the second guard 304 or the second side wall 406 of the first guard 302 and the second side wall 506 of the second guard 304, the first lock 306 and/or the second lock 308 can be utilized with any of the side walls of the first guard 302 and the second guard 304. Furthermore, while two locks are illustrated and discussed, in some examples, only a single lock (e.g., the first lock 306 or the second lock 308) may be included.

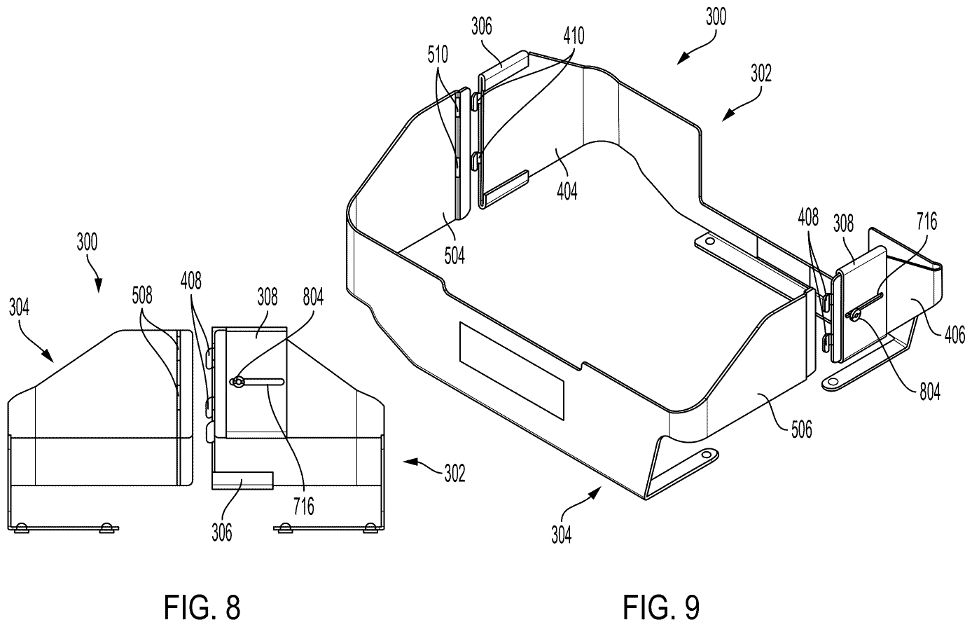

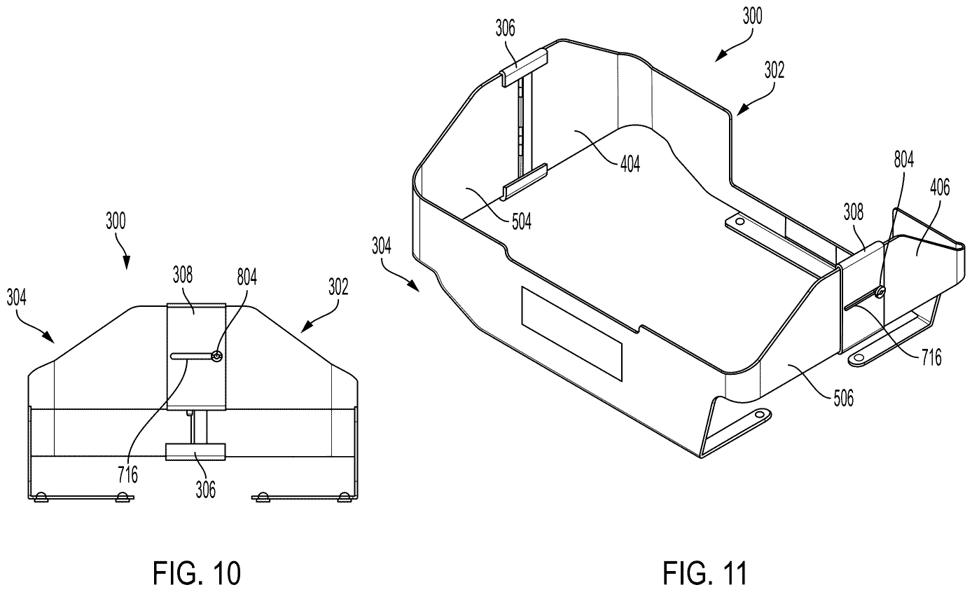

Referring now to FIGS. 8-11, the first guard 302 and the second guard 304 are shown. In aspects, the at least one first coupling element 408 of the first guard 302 can be configured to engage the at least one first mating coupling element 508 of the second guard 304 to couple the first guard 302 and the second guard 304 together. Additionally or alternatively, in aspects, the at least one second coupling element 410 of the first guard 302 can be configured to engage the at least one second mating coupling element 510 of the second guard 304 to couple the first guard 302 and the second guard 304 together. For example, FIGS. 8-9 illustrate the first guard 302 and the second guard 304 in close proximity to one another, but the at least one first coupling element 408 and the at least one second coupling element 410 of the first guard 302 have not engaged the at least one first mating coupling element 508 and the at least one second mating coupling element 510 of the second guard 304. In contrast, FIGS. 10-11 illustrate the at least one first coupling element 408 and the at least one second coupling element 410 of the first guard 302 engaged with the at least one first mating coupling element 508 and the at least one second mating coupling element 510 of the second guard 304 to couple the first guard 302 and the second guard 304 together.

In aspects, the first lock 306 and/or the second lock 308 can be configured to slide between the unlocked orientation (shown generally in FIGS. 8 and 9) and the locked orientation (shown in FIGS. 10-11) when the first guard 302 and the second guard 304 are coupled together. In aspects, the unlocked orientation can be configured to permit decoupling of the first guard 302 and the second guard 304, and the locked orientation can be configured to prevent decoupling of the first guard 302 and the second guard 304.

In aspects, the unlocked orientation can comprise the first lock 306 extending over at most one of the first side wall 404 of the first guard 302 or the first side wall 504 of the second guard 304. Additionally or alternatively, the unlocked orientation can comprise the second lock 308 extending over both of the second side wall 406 of the first guard 302 and the second side wall 506 of the second guard 304. While FIGS. 8 and 9 illustrate the first guard 302 and the second guard 304 in close proximity to one another, but not coupled together, in some examples, the first guard 302 and the second guard 304 can be coupled to one another (e.g., via the coupling elements and the coupling elements) while the first lock 306 and the second lock 308 can be in the unlocked position, as illustrated. In aspects, as shown in FIGS. 10-11, the locked orientation can comprise the first lock 306 extending over both of the first side wall 404 of the first guard 302 and the first side wall 504 of the second guard 304.

In some aspects, the cladding protection device 300 can include a first coupling member 802 configured to slidably secure the first lock 306 to at least one of the first side wall 404 of the first guard 302 and the first side wall 504 of the second guard 304 and/or maintain the first lock 306 in the locked or unlocked orientation. In the embodiment shown, the first coupling member 802 can extend through the elongated slot 616 of the first lock 306 and be secured to one of the first side wall 404 of the first guard 302 or the first side wall 504 of the second guard 304. This can enable the first lock 306 to be slidably movable relative to the first guard 302 and/or the second guard 304. In this way, the elongated slot 616 can guide the first lock 306 when sliding between the unlocked and locked orientations. Similarly, the cladding protection device 300 can include a second coupling member 804 configured to slidably secure the second lock 308 to at least one of the second side wall 406 of the first guard 302 and the second side wall 506 of the second guard 304 and/or maintain the second lock 308 in the locked or unlocked orientation. The second lock 308 can function similar to the first lock 306 described above.

The first coupling member 802 and the second coupling member 804 can be similar or different to one another and can include any suitable type of coupling member. In some non-limiting examples, the first coupling member 802 and the second coupling member 804 can include pins and dowel pins, bolts and nuts, screws, studs, rods, posts, clips, rivets, male and female threaded engagements, or other pin-like or projection-type members.

Referring to FIGS. 8-11, a method of assembling the cladding protection device 300 about the column 106 will be described with additional reference to FIGS. 1-7C. In aspects, the method can comprise positioning the second guard 304 of the cladding protection device 300 around a first portion of the perimeter of the column 106 to at least partially surround the column 106. For example, the second guard 304 can be positioned on the base 104 about the perimeter of the column 106 to at least partially enclose or surround the column 106.

In aspects, the method can comprise coupling the first guard 302 and the second guard 304 together in an initial coupling step. In aspects, coupling the first guard 302 and the second guard 304 together in the initial coupling step can comprise engaging the at least one first coupling element 408 of the first side wall 404 of the first guard 302 with the at least one first mating coupling element 508 of the first side wall 504 of the second guard 304. In one example, the L-shaped projections of the first side wall 404 of the first guard 302 can engage the slots formed in the first side wall 504 of the second guard 304. In some examples, engaging the at least one first coupling element 408 of the first side wall 404 of the first guard 302 with the at least one first mating coupling element 508 of the first side wall 504 of the second guard 304 can further comprise arranging the first guard 302 at a position offset from its final assembled position with respect to the second guard 304. In the embodiment shown, the first guard 302 includes the L-shaped projections and is positioned such that the L-shaped projections may be inserted into the slots in the second guard 304. In one example, the second guard 304 may be positioned such that the first side wall 504 of the second guard 304 is substantially perpendicular to the first side wall 404 of the first guard 302 when the L-shaped projections are first received within the slots. However, it is contemplated that the first side wall 404 of the first guard 302 and the first side wall 504 of the second guard 304 may be positioned at other angles so long as the L-shaped projections of the first side wall 404 of the first guard 302 may be inserted into the slots of the first side wall 504 of the second guard 304.

In aspects, the L-shaped projections of the first side wall 404 of the first guard and the slots of the first side wall 504 of the second guard 304 may be positioned and dimensioned so that once the tab portions of the L-shaped projections pass into the slots, the first guard 302 may be lowered such that the tab portions of the L-shaped projections extend below a lower edge of the slots of the first side wall 504 of the second guard 304. In this position, the tab portions of the L-shaped projections secure the first guard 302 to the second guard 304 to prevent the first side wall 404 of the first guard 302 from being detached from the first side wall 504 of the second guard 304. It is contemplated that the L-shaped projections and the slots may be positioned and dimensioned so that once the first guard 302 is lowered, a lower edge of the horizontal portions of the L-shaped projection engage or are slightly offset from the corresponding lower edge of the slots.

In aspects, the method can further comprise positioning the first guard 302 of the cladding protection device 300 around a second portion of a perimeter of the column 106 to at least partially surround the column 106. In one example, positioning the first guard 302 of the cladding protection device 300 around the second portion of the perimeter of the column 106 to at least partially surround the column 106 can further comprise pivoting the first guard 302 relative to the second guard 304 to at least partially surround the column 106. For example, after the L-shaped projections are fully engaged with the slots of the first side wall 504 of the second guard 304, the first guard 302 can be pivoted relative to the second guard 304 about the column 106. In particular, the L-shaped projections and the slots of the first side wall 504 of the second guard 304 can function as hinges or pivot points that allow the first guard 302 to freely rotate relative to the second guard 304 when the L-shaped projections are extended through the slots of the first side wall 504 of the second guard 304. In some examples, as described above, the first guard 302 can be pivoted relative to the second guard 304 after engaging the at least one first coupling element 408 of the first side wall 404 of the first guard 302 with the at least one first mating coupling element 508 of the first side wall 504 of the second guard 304.

In aspects, the method can further comprise aligning the first side wall 404 of the first guard 302 with the first side wall 504 of the second guard 304 and/or aligning the second side wall 406 of the first guard 302 with the second side wall 506 of the second guard 304. For example, the first guard 302 can be pivoted (e.g., rotated) until the first side wall 404 of the first guard 302 is substantially aligned (e.g., and substantially parallel) with the first side wall 504 of the second guard 304. In some examples, when the first side wall 404 of the first guard 302 is substantially aligned with the first side wall 504 of the second guard 304, the second side wall 406 of first guard 302 can also be substantially aligned (e.g., and substantially parallel) with the second side wall 506 of the second guard 304. In aspects, this step can be performed after the initial coupling step, but prior to the final coupling step (discussed below).

In aspects, the method can comprise coupling the first and second guards together to retain the first guard 302 and the second guard 304 in a final coupling step. In the shown embodiment, in this position, the L-shaped projections extending from the second side wall 406 of the first guard 302 can engage the slots formed in the second side wall 506 of the second guard 304. It is noted that the bend or skew of the L-shaped projections of the second side wall 406 of the first guard 302 inwardly relative to the second side wall 406 of the first guard 302 enables the L-shaped projections to be received by the slots of the second side wall 506 of the second guard 304 when the second side wall of the first guard 302 is substantially aligned with and parallel to the second side wall 506 of the second guard 304. For example, the L-shaped projections of the second side wall 406 of the first guard 302 can be bent or skewed to enable them to extend through the slots of the second side wall 506 of the second guard 304 when the second side wall 406 of the first guard 302 is moved into engagement with the second side wall 506 of the second guard 304. It is contemplated that the second side wall 406 of the first guard 302 may be lifted slightly to enable the L-shaped projections of the second side wall 406 of the first guard 302 (and the tab portions thereof) to clear the slots of the second side wall 506 of the second guard 304 and be extended therethrough.

When the L-shaped projections of the second side wall 406 of the first guard 302 are extended through the slots of the second side wall 506 of the second guard 304, the second side wall 406 of the first guard 302 may be lowered to rest on the base 104 of the surgical table 100 (see FIG. 1, generally). As the first guard 302 is lowered, the tab portions of the L-shaped projections of the second side wall 406 of the first guard 302 can extend below a lower edge of the slots of the second side wall 506 of the second guard 304 to prevent the second side wall 506 of the second guard 304 from being detached from the second side wall 406 of the first guard 302. For example, the tab portions of the L-shaped projections of the second side wall 406 of the first guard 302 can secure the second side wall 406 of the first guard 302 to the second side wall 506 of the second guard 304. With the L-shaped projections of the second side wall 406 of the first guard 302 fully engaged with the slots of the second side wall 506 of the second guard 304, the cladding protection device 300 will bound a central area that is dimensioned to enclose or surround the entire lower perimeter of the column 106 (see FIG. 1). For example, the first guard 302 and the second guard 304 together will entirely surround the perimeter of the column 106.

In aspects, the method can further comprise locking the first guard 302 and the second guard 304 together to prevent decoupling of the first guard 302 from the second guard 304. In one example, locking the first guard 302 and the second guard 304 together can comprise sliding the first lock 306 from the unlocked orientation to the locked orientation. Additionally or alternatively, locking the first guard 302 and the second guard 304 together can comprise sliding the second lock 308 from the unlocked orientation to the locked orientation. In the particular embodiment shown, once the first guard 302 and the second guard 304 are positioned as described above, the first lock 306 and the second lock 308 can be slid such that the curved flanges (e.g., see the first curved flange 608 and the second curved flange 612 in FIGS. 6A-6C) extend over the upper or lower edges of the first side wall 404 of the first guard 302 and the upper or lower edges of the first side wall 504 of the second guard 304 (see FIGS. 10 and 11). For example, as illustrated in FIGS. 10 and 11, a portion of the top curved flange of the first lock 306 extends over an upper edge of the first side wall 404 of the first guard 302 and the remaining portion of the top curved flange of the first lock 306 extends over an upper edge of the first side wall 504 of the second guard 304. Similarly, a portion of the bottom curved flange of the first lock 306 extends over a bottom edge of the first side wall 404 of the first guard 302 and a remaining portion of the bottom curved flange of the first lock 306 extends over a bottom edge of the first side wall 504 of the second guard 304. The second lock 308 is similarly positioned over the upper and lower edges of the other walls of the first guard 302 and the second guard 304. Accordingly, when the first lock 306 and/or the second lock 308 are in the locked orientation (described above), the first lock 306 and the second lock 308 prevent the first guard 302 and the second guard 304 from pivoting and/or moving vertically relative to each other, thereby securing or locking the first guard 302 and the second guard 304 together. It is contemplated that a user must slide the first lock 306 and the second lock 308 to the unlocked orientation (described above) before unlocking the first guard 302 and the second guard 304 from each other. As described previously, the unlocked orientation of the first lock 306 corresponds to an entirety of the top curved flange of the first lock 306 extending over the upper and lower edges of the first side wall 404, 504 of only one of the first guard 302 or the second guard 304. Similarly, the unlocked orientation of the second lock 308 corresponds to an entirety of the top curved flange of the second lock 308 extending over the upper and lower edges of the second side wall 406, 506 of only one of the first guard 302 or the second guard 304.

In the embodiment shown in FIGS. 8-9, the unlocked orientation of the first lock 306 and the second lock 308 are shown as being positioned on the first guard 302. However, it is contemplated that in some embodiments the unlocked orientation of the first lock 306 and the second lock 308 may correspond to both the first lock 306 and the second lock 308 being fully positioned on the second guard 304. It is further contemplated that another alternative unlocked orientation of the first lock 306 and the second lock 308 may correspond to one of the first lock 306 or the second lock 308 being fully positioned on the first guard 302 and the other of the first lock 306 or the second lock 308 being fully positioned on the second guard 304. It is contemplated that the first coupling member 802 and the second coupling member 804 that allows the corresponding lock 306, 308 to slide may be tightened to prevent movement of the corresponding lock 306, 308 once the locks 306, 308 are moved to the locked orientation (see FIGS. 10 and 11).

In the illustrated examples, the cladding protection device 300 is configured to surround the entire perimeter of the column 106 (FIG. 1). In other embodiments, it is contemplated that the cladding protection device 300 may bound less than the entire perimeter (not shown) of the column 106 (FIG. 1). Additionally, the cladding protection device 300 may protect a predetermined vertical distance of the column 106 (FIG. 1), for example up to about 12 inches relative to the base 104 (FIG. 1) of the surgical table 100 (FIG. 1). In other embodiments (not shown), the cladding protection device 300 may be configured to protect a lesser or greater vertical extent of the column 106 (FIG. 1). In some embodiments, it is contemplated that the first guard 302 and the second guard 304 may respectively include more than three vertically extending walls based on the shape of the column 106 (FIG. 1). It is also contemplated that the walls may extend at different angles versus that which is shown in the illustrated embodiments. It is also contemplated that in alternative embodiments (not shown) the L-shaped projections may be formed in the second guard 304 and the slots may be formed in the first guard 302 so that the cladding protection device 300 is assembled by rotating the second guard 304 relative to the first guard 302.

In the illustrated examples, the side walls of the first guard 302 and the second guard 304 are not the same height and the central wall of the first guard 302 includes a bigger notch than the central wall of the second guard 304. It is contemplated the side walls and/or the central walls of the first guard 302 and the second guard 304 may be identical or may be contoured to have other features, for example, but not limited to holes, notches, slots, etc.

In the embodiment described above, the first guard 302 and the second guard 304 both are generally U-shaped as defined by the respective central walls, first side walls and second side walls. It is contemplated that the first guard 302 and the second guard 304 may have other shapes, for example, but not limited to, L-shaped, arcuate, etc. so long as the first guard 302 includes a first free end with first coupling element(s) and an opposite second free end with second coupling elements, and the second guard 304 includes a first free end with first mating coupling elements and a second free end with second mating coupling elements so that the first guard 302 and the second guard 304 may be coupled together to bound a central area.

While the second guard 304 includes the at least one first mating coupling element 508 (e.g., slots) and the at least one second mating coupling element 510 (e.g., slots), and the first guard 302 includes the at least one first coupling element 408 (e.g., the L-shaped projections) and the at least one second coupling element 410 (e.g., the L-shaped projections), in an alternative embodiment (not shown), it is contemplated that the at least one first mating coupling element 508 and/or the at least one second mating coupling element 510 (e.g., slots) may be formed in the first guard 302 and the at least one first coupling element 408 and/or the at least one second coupling element 410 (e.g., L-shaped projections) may be formed in the second guard 304 so long as the at least one first mating coupling element 508 and/or the at least one second mating coupling element 510 and the at least one first coupling element 408 and/or the at least one second coupling element 410 allow the first guard 302 and the second guard 304 to be coupled to and/or pivot relative to each other. In other embodiments (not shown), the first guard 302 and/or the second guard 304 may include both the at least one first mating coupling element 508 and/or the at least one second mating coupling element 510 and the at least one first coupling element 408 and/or the at least one second coupling element 410 so long as the at least one first mating coupling element 508 and/or the at least one second mating coupling element 510 and the at least one first coupling element 408 and/or the at least one second coupling element 410 allow the first guard 302 and the second guard 304 to be coupled to and/or pivot relative to each other. It is also contemplated that the number of respective coupling elements and/or mating coupling elements may be fewer or greater than that shown in the embodiments without departing from the scope of the present disclosure.

It should be understood that any feature, component, element, or function described in connection with the cladding protection device 300 disclosed herein may be utilized interchangeably, or in any suitable combination, with any other feature, component, element, or function of any embodiment. Moreover, unless expressly stated otherwise, any such feature may be implemented on, integrated with, or applied to different portions, regions, or operational aspects of the cladding protection device 300 as appropriate or desirable. All such variations, substitutions, and modifications are considered to fall within the scope and spirit of the present disclosure.
1 It should be understood that while various aspects have been described in detail relative to certain illustrative and specific examples thereof, the present disclosure should not be considered limited to such, as numerous modifications and combinations of the disclosed features are possible without departing from the scope of the following claims.

In accordance with the disclosure, non-limiting aspects of the disclosure will now be described. Various combinations of the aspects can be provided in accordance with the disclosure.

Aspect 1. A cladding protection device for placement around a column. The cladding protection device comprising a first guard comprising a first side wall. The cladding protection device further comprising at least one first coupling element on a free end portion of the first side wall of the first guard. The cladding protection device further comprising a second guard comprising a first side wall. The cladding protection device still further comprising at least one first mating coupling element on a free end portion of the first side wall of the second guard. The at least one first coupling element of the first guard is configured to engage the at least one first mating coupling element of the second guard to couple the first guard and the second guard together. The cladding protection device still further comprising at least one lock configured to slide between an unlocked orientation and a locked orientation when the first guard and the second guard are coupled together. The unlocked orientation is configured to permit decoupling of the first guard and the second guard, and the locked orientation is configured to prevent decoupling of the first guard and the second guard.

Aspect 2. The cladding protection device of Aspect 1, wherein the first guard further comprises a central wall and a second side wall, the first side wall and the second side wall of the first guard positioned at opposite ends of the central wall and extending from a side of the central wall.

Aspect 3. The cladding protection device of Aspect 2, further comprising at least one second coupling element on a free end portion of the second side wall of the first guard.

Aspect 4. The cladding protection device of Aspect 1, wherein the second guard further comprises a central wall and a second side wall, the first side wall and the second side wall of the second guard positioned at opposite ends of the central wall of the second guard and extending from a side of the central wall of the second guard.

Aspect 5. The cladding protection device of Aspect 4, further comprising at least one second mating coupling element on a free end portion of the second side wall of the second guard.

Aspect 6. The cladding protection device of Aspect 1, wherein the at least one first coupling element of the first guard comprises an L-shaped projection extending from the free end portion of the first side wall of the first guard.

Aspect 7. The cladding protection device of Aspect 1, wherein the at least one first mating coupling element of the second guard comprise a slot formed in the free end portion of the first side wall of the second guard.

Aspect 8. The cladding protection device of Aspect 1, wherein the at least one lock comprises: a base portion comprising a top edge and a bottom edge; a first curved flange formed at the top edge of the base portion and defining an opening configured to slidably receive an upper edge of the first side wall of the first guard and an upper edge of the first side wall of the second guard; and a second curved flange formed at the bottom edge of the base portion and defining an opening configured to slidably receive a lower edge of the first side wall of the first guard and a lower edge of the first side wall of the second guard.

Aspect 9. The cladding protection device of Aspect 1, further comprising a coupling member configured to slidably secure the at least one lock to at least one of the first side wall of the first guard and the first side wall of the second guard and/or maintain the at least one lock in the locked or unlocked orientation.

Aspect 10. The cladding protection device of Aspect 1, wherein the locked orientation comprises the at least one lock extending over each of the first side wall of the first and the first side wall of the second guard.

Aspect 11. The cladding protection device of Aspect 1, wherein the unlocked orientation comprises the at least one lock extending over one of the first side wall of the first guard or the first side wall of the second guard.

Aspect 12. A surgical table comprising: a patient support surface and a base, a column extending between the base and the patient support surface, and the cladding protection device of Aspect 1, wherein the cladding protection device is positioned at least partially around the column.

Aspect 13. A method of assembling the cladding protection device of Aspect 1 about the column, the method comprising: positioning the first guard of the cladding protection device around a first portion of a perimeter of the column to at least partially surround the column; positioning the second guard of the cladding protection device around a second portion of the perimeter of the column to at least partially surround the column; and coupling the first guard and the second guard together to retain the column between the first guard and the second guard; and locking the first guard and the second guard together to prevent decoupling of the first guard from the second guard.

Aspect 14. The method of Aspect 13, wherein coupling the first guard and the second guard together comprises engaging the at least one first coupling element of the first side wall of the first guard with the at least one first mating coupling element of the first side wall of the second guard.

Aspect 15. The method of Aspect 13, wherein prior to coupling the first guard and the second guard together, the method further comprises aligning the first side wall of the first guard with the first side wall of the second guard.

Aspect 16. The method of Aspect 13, wherein positioning the second guard of the cladding protection device around the second portion of the perimeter of the column to at least partially surround the column further comprises pivoting the second guard relative to the first guard to at least partially surround the column.

Aspect 17. The method of Aspect 13, wherein coupling the first guard and the second guard together comprises engaging the at least one first coupling element of the first side wall of the first guard with the at least one first mating coupling element of the first side wall of the second guard.

Aspect 18. The method of Aspect 17, wherein positioning the second guard of the cladding protection device around the second portion of the perimeter of the column to at least partially surround the column comprises pivoting the second guard relative to the first guard to at least partially surround the column, wherein the second guard is pivoted relative to the first guard after engaging the at least one first coupling element of the first side wall of the first guard with the at least one first mating coupling element of the first side wall of the second guard.

Aspect 19. The method of Aspect 13, wherein locking the first guard and the second guard together comprises sliding the first lock from the unlocked orientation to the locked orientation.

Aspect 20. The method of Aspect 13, wherein the first guard and the second guard together entirely surround the perimeter of the column.

What is claimed is:

1. A cladding protection device for placement around a column, the cladding protection device comprising:
a first guard comprising a first side wall;
at least one first coupling element on a free end portion of the first side wall of the first guard;
a second guard comprising a first side wall;
at least one first mating coupling element on a free end portion of the first side wall of the second guard, wherein the at least one first coupling element of the first guard is configured to engage the at least one first mating coupling element of the second guard to couple the first guard and the second guard together; and
at least one lock configured to slide between an unlocked orientation and a locked orientation when the first guard and the second guard are coupled together, wherein the unlocked orientation is configured to permit decoupling of the first guard and the second guard, and the locked orientation is configured to prevent decoupling of the first guard and the second guard.

2. The cladding protection device of claim 1, wherein the first guard further comprises a central wall and a second side wall, the first side wall and the second side wall of the first guard positioned at opposite ends of the central wall and extending from a side of the central wall.

3. The cladding protection device of claim 2, further comprising at least one second coupling element on a free end portion of the second side wall of the first guard.

4. The cladding protection device of claim 1, wherein the second guard further comprises a central wall and a second side wall, the first side wall and the second side wall of the second guard positioned at opposite ends of the central wall of the second guard and extending from a side of the central wall of the second guard.

5. The cladding protection device of claim 4, further comprising at least one second mating coupling element on a free end portion of the second side wall of the second guard.

6. The cladding protection device of claim 1, wherein the at least one first coupling element of the first guard comprises an L-shaped projection extending from the free end portion of the first side wall of the first guard.

7. The cladding protection device of claim 1, wherein the at least one first mating coupling element of the second guard comprise a slot formed in the free end portion of the first side wall of the second guard.

8. The cladding protection device of claim 1, wherein the at least one lock comprises:
a base portion comprising a top edge and a bottom edge;
a first curved flange formed at the top edge of the base portion and defining an opening configured to slidably receive an upper edge of the first side wall of the first guard and an upper edge of the first side wall of the second guard; and
a second curved flange formed at the bottom edge of the base portion and defining an opening configured to slidably receive a lower edge of the first side wall of the first guard and a lower edge of the first side wall of the second guard.

9. The cladding protection device of claim 1, further comprising a coupling member configured to slidably secure the at least one lock to at least one of the first side wall of the first guard and the first side wall of the second guard and/or maintain the at least one lock in the locked orientation or the unlocked orientation.

10. The cladding protection device of claim 1, wherein the locked orientation comprises the at least one lock extending over each of the first side wall of the first guard and the first side wall of the second guard.

11. The cladding protection device of claim 1, wherein the unlocked orientation comprises the at least one lock extending over one of the first side wall of the first guard or the first side wall of the second guard.

12. A surgical table comprising:
a patient support surface and a base,
the column extending between the base and the patient support surface, and
the cladding protection device of claim 1, wherein the cladding protection device is positioned at least partially around the column.

13. A method of assembling the cladding protection device of claim 1 about the column, the method comprising:
positioning the first guard of the cladding protection device around a first portion of a perimeter of the column to at least partially surround the column;
positioning the second guard of the cladding protection device around a second portion of the perimeter of the column to at least partially surround the column; and
coupling the first guard and the second guard together to retain the column between the first guard and the second guard; and
locking the first guard and the second guard together to prevent decoupling of the first guard from the second guard.

14. The method of claim 13, wherein coupling the first guard and the second guard together comprises engaging the at least one first coupling element of the first side wall of the first guard with the at least one first mating coupling element of the first side wall of the second guard.

15. The method of claim 13, wherein prior to coupling the first guard and the second guard together, the method further comprises aligning the first side wall of the first guard with the first side wall of the second guard.

16. The method of claim 13, wherein positioning the second guard of the cladding protection device around the second portion of the perimeter of the column to at least partially surround the column further comprises pivoting the second guard relative to the first guard to at least partially surround the column.

17. The method of claim 13, wherein coupling the first guard and the second guard together comprises engaging the at least one first coupling element of the first side wall of the first guard with the at least one first mating coupling element of the first side wall of the second guard.

18. The method of claim 17, wherein positioning the second guard of the cladding protection device around the second portion of the perimeter of the column to at least partially surround the column comprises pivoting the second guard relative to the first guard to at least partially surround the column, wherein the second guard is pivoted relative to the first guard after engaging the at least one first coupling element of the first side wall of the first guard with the at least one first mating coupling element of the first side wall of the second guard.

19. The method of claim 13, wherein locking the first guard and the second guard together comprises sliding the at least one lock from the unlocked orientation to the locked orientation.

20. The method of claim 13, wherein the first guard and the second guard together entirely surround the perimeter of the column.
